(19) United States
(12) Patent Application Publication
(10) Pub. No.: US 2011/0271229 A1
(43) Pub. Date: Nov. 3, 2011

(54) APPARATUS AND METHOD FOR DETERMINING POP-UP MENU IN PORTABLE TERMINAL

(75) Inventor: Yong-Ju YU, Seoul (KR)

(73) Assignee: SAMSUNG ELECTRONICS CO., LTD., Gyeonggi-Do (KR)

(21) Appl. No.: 13/098,591

(22) Filed: May 2, 2011

(30) Foreign Application Priority Data
May 3, 2010 (KR) 10-2010-0041388

(51) Int. Cl. G06F 3/048

(52) U.S. Cl. 715/808

(57) ABSTRACT

An apparatus and a method for touch input in a portable terminal, more specifically, an apparatus and a method for determining a pop-up menu set in a particular menu using a short touch. The apparatus preferably includes a controller for detecting a menu touch input for executing a function; and a pop-up menu guide unit for determining whether or not a pop-up menu is set in the menu detected by the controller and processing information to be output regarding whether or the pop-up menu is set, according to the determination.

### CLAIM OF PRIORITY

The present application claims the benefit of priority under 35 U.S.C. §119(a) from Korean patent application Serial No. 10-2010-0041388, filed in the Korean Intellectual Property Office on May 3, 2010, the entire contents of which is hereby incorporated by reference in its entirety.

### BACKGROUND OF THE INVENTION

1. Field of the Invention

The present invention relates generally to an apparatus and a method for inputting touch in a portable terminal. More particularly, the present invention relates to an apparatus and a method for determining a pop-up menu set in a particular menu using a short touch.

2. Description of the Related Art

Recent use of portable terminals is drastically increasing thanks to ever-increasing functionality coupled with portability. To acquire more users, service providers (terminal manufacturers) compete to develop the portable terminal with ever-increasing amounts of convenient functions.

For example, portable terminals nowadays can provide functions such as a phonebook, a game, a scheduler, a Short Message Service (SMS), a Multimedia Message Service (MMS), a Broadcast Message Service (BMS), an Internet service, an electronic (E) mail service, a wakeup call, a Motion Picture Expert Group (MPEG)-1 or MPEG-2 Audio Layer-3 (MP3) player, a digital camera, and other similar products and services.

A user of the portable terminal can execute a particular function by, for example, activating an iconized menu.

The iconized menu characterizes respective functions, and can be changed to features as requested by the user.

In more detail, when the portable terminal provides a camera icon, the user can change a name of the camera icon and a program linked to the camera icon. By doing so, the user can activate a menu (a pop-up menu) additionally provided for the icon by inputting the camera icon long.

When the pop-up menu is activated, the user can execute his/her wanted function in the output menu.

However, such a pop-up menu is provided for the particular icon, such as the camera icon, not for every icon. Accordingly, the user needs to recognize the icon providing the pop-up menu and then activate the pop-up menu for the corresponding icon.

To address this shortcoming, there is a need in the art for an apparatus and a method for easily determining the icon providing the pop-up menu.

### SUMMARY OF THE INVENTION

An exemplary aspect of the present invention is to substantially solve at least the above problems and/or disadvantages and to provide at least the advantages below. Accordingly, an aspect of the present invention provides an apparatus and a method for determining a pop-up menu set in a particular menu in a portable terminal.

Another exemplary aspect of the present invention is to provide an apparatus and a method for determining a pop-up menu set in a particular menu through a menu selection input in a portable terminal.

Yet another exemplary aspect of the present invention is to provide an apparatus and a method for determining whether a pop-up menu is set in a corresponding menu when a portable terminal detects an input for menu selection.

According to an exemplary aspect of the present invention, an apparatus for determining a pop-up menu in a portable terminal is provided. The apparatus preferably includes a controller for detecting a menu touch input for executing a function; and a pop-up menu guide unit for determining whether a pop-up menu is set in the menu detected by the controller and processing to output information regarding whether or not the pop-up menu is set according to the determination.

According to another exemplary aspect of the present invention, a method for determining a pop-up menu in a portable terminal is provided. The method includes detecting a menu touch input for executing a function; determining whether a pop-up menu is set in the menu of the touch input; and outputting information of whether the pop-up menu is set according to the determination.

According to yet another exemplary aspect of the present invention, an apparatus for determining a pop-up menu in a portable terminal is provided. The apparatus preferably includes an input unit for detecting a menu touch input for executing a menu function; a controller for determining the touch input for determining the pop-up menu by determining the touch input of the input unit, and determining whether or not a pop-up menu is set in the menu for the function execution; a pop-up menu guide unit for, when the controller determines the pop-up menu in the detected menu, providing information regarding whether or not the pop-up menu is set; and a display unit for outputting the information provided from the pop-up guide unit.

Other exemplary aspects, advantages, and salient features of the invention will become more apparent to persons of ordinary skill in the art from the following detailed description, which, taken in conjunction with the annexed drawings, discloses exemplary embodiments of the invention.

Before undertaking the DETAILED DESCRIPTION OF THE INVENTION below, definitions of certain words and phrases used throughout this patent document are set forth: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of a portable terminal for determining a particular menu including a pop-up menu according to an exemplary embodiment of the present invention;

FIG. 2 is a flowchart of a method for determining the pop-up menu set in the particular menu in the portable terminal according to an exemplary embodiment of the present invention;

FIG. 3A is a diagram of the pop-up menu determination in a conventional portable terminal;

FIG. 3B is a diagram of the pop-up menu determination in the portable terminal according to an exemplary embodiment of the present invention; and

FIG. 4 is a flowchart of a method for informing of the pop-up menu in the portable terminal according to an exemplary embodiment of the present invention.

Throughout the drawings, like reference numerals will be understood to refer to like parts, components and structures.

### DETAILED DESCRIPTION

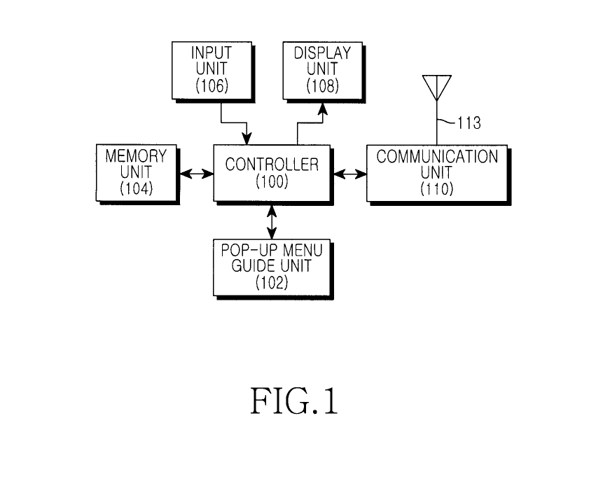

FIGS. 1 through 4, as discussed below, and the various exemplary embodiments used to describe the principles of the present disclosure in this patent document are by way of illustration only and should not be construed in any way to limit the scope of the claimed invention to the examples in the disclosure. Those skilled in the art will understand that the principles of the present disclosure may be implemented in any suitably arranged portable terminal.

Exemplary embodiments of the present invention provide an apparatus and a method for determining an icon for a pop-up menu in a portable terminal. Hereinafter, the pop-up menu, which an item for an additional function in a particular menu, indicates functions for name change of the particular menu, connected program change, and icon copy.

FIG. 1 is a block diagram of a portable terminal for determining a particular menu including a pop-up menu according to an exemplary embodiment of the present invention.

The portable terminal of FIG. 1 can preferably include, for example, a controller 100, a pop-up menu guide unit 102, a memory unit 104, an input unit 106, a display unit 108, and a communication unit 110. The portable terminal may include additional units that are not illustrated here merely for sake of clarity. Similarly, the functionality of two or more of the above units may be integrated into a single component.

The controller 100, which typically includes a processor or microprocessor, controls operations of the portable terminal. For example, the controller 100 processes and controls voice communication and data communication. In addition to the typical functions, upon detecting a user's input for selecting a particular menu, the controller 100 determines whether a pop-up menu is set in the particular menu input by the user, and processes to provide the determination result to the user.

When the user's touch input is detected under control of the controller 100, the pop-up menu guide unit 102 determines whether the pop-up menu is set in the particular menu corresponding to the location of the touch input.

Next, the pop-up menu guide unit 102 provides the user of the portable terminal with the determined pop-up menu setting of the particular menu.

For instance, when the user touches a particular menu, the pop-up menu guide unit 102 can inform of the pop-up menu setting by outputting the icon notifying that the pop-up menu is set in the particular menu.

Accordingly, the user can determine base on the output icon that the pop-up menu is set in the input particular menu, and request to determine the set pop-up menu.

After determining that the user is well-aware of the pop-up menu set in the particular menu, the pop-up menu guide unit 102 can operate so as not to provide the pop-up menu setting information, even when the menu is touched on a touch screen.

That is, the pop-up menu guide unit 102 defines the maximum number of times per menu for guiding whether the pop-up menu is set, and then processes to provide the information of whether the pop-up menu is set for less than the defined number of times.

The memory unit 104 preferably includes machine readable medium such as a Read Only Memory (ROM), a Random Access Memory (RAM), a flash ROM, or other similar storage devices. The ROM contains microcodes and reference data of programs for processing and controlling the controller 100 and the pop-up menu guide unit 102.

The RAM, which is the preferable working memory of the controller 100, stores temporary data generating in the program execution. The flash ROM stores updatable storage data such as phonebook, outgoing messages, and incoming messages.

The input unit 106 includes a plurality of function keys such as number key buttons 0˜9, menu button, Cancel button, OK button, Call button, End button, Internet access button, navigation key buttons, character input keys, and other similar input keys and buttons. The input unit 106 provides the controller 100 with key input data corresponding to the key pressed by the user. A person of ordinary skill in the art should understand and appreciate that the display unit and input unit could be a single touch screen.

The display unit 108 displays status information, as well as a limited number of characters, videos, and still images during the operation of the portable terminal. The display unit 108 can employ a color Liquid Crystal Display (LCD), an Active Mode Organic Light Emitting Diode (AMOLED) display, and any other similar display apparatuses, especially thin-film technology displays. When the display unit 108 includes a touch input device and is applied to a touch-type portable terminal, it can be used as the input device.

The communication unit 110 operates to transmit and receive radio signals of data input and output via an antenna 113. For instance, in the transmission, the communication unit 110 channel-encodes, spreads, Radio Frequency (RF)-processes, and transmits data. In the reception, the communication unit 110 converts the received RF signal to a baseband signal and restores the data by decoding the baseband signal in any of a plurality of protocols, including but in no way limited to de-spreading and channel-decoding, time division, orthogonal frequency division, etc., just to name a few possibilities.

While the controller 100 of the portable terminal can serve as the pop-up menu guide unit 102, they are separately illustrated here to distinguish their own functions, and not to limit the scope of the invention. One skilled in the art shall understand that various modifications can be made without departing from the spirit and scope of the claimed invention. For example, the controller 100 can process all of the functions of the pop-up menu guide unit 102.

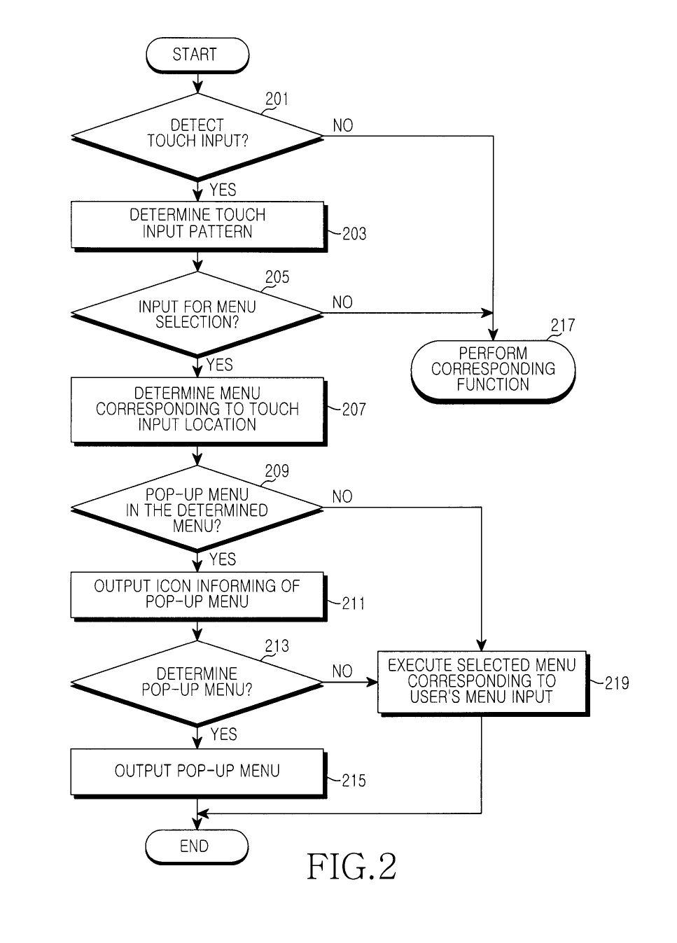

FIG. 2 is a flowchart of a method for determining the pop-up menu set in the particular menu in the portable terminal according to an exemplary embodiment of the present invention.

Referring now to FIG. 2, in step 201, the portable terminal determines whether the user's touch input is detected.

When the user's touch input is not detected in step 201, the portable terminal performs a corresponding function (e.g., standby mode) in step 217.

Upon detecting the user's touch input in step 201, the portable terminal determines a touch input pattern in step 203. Herein, the touch input pattern is the input pattern for touching the particular menu output from the portable terminal and can include a short touch input and a long touch input. The short touch input is recognized for selecting and executing the output particular menu, and the long touch input is recognized for activating the pop-up menu set in the output particular menu. The long and short touch inputs are relative time values with regard to a duration of time that is known by a person of ordinary skill in the art.

In step 205, the portable terminal determines whether the touch input pattern is a touch pattern for selecting the menu in step 203.

When determining in step 205 that the touch input constitutes a long touch input to activate the pop-up menu in step 205, the portable terminal performs the corresponding function (for example, activates the pop-up menu for the touched menu) in step 217.

By contrast, when determining in step 205 that the touch input constitutes a short touch input to select a particular menu, the portable terminal determines the particular menu corresponding to the touch input in step 207 and determines whether the determined menu includes the pop-up menu in step 209.

When the determined menu at step 209 does not include a pop-up menu, the portable terminal executes the menu determined in step 207, in step 219.

When the determined menu at step 209 includes the pop-up menu, the portable terminal outputs in step 211 the icon notifying that the pop-up menu is set (e.g. a pop-up menu set icon) in the particular menu touched by the user.

Herein, the icon notifying that the pop-up menu is set informs of the pop-up menu setting so that the user can request to determine the pop-up menu. The icon can employ a digital timer, a sandglass, and a progress bar, which can indicate the time for the request from the user. The portable terminal can output items of the pop-up menu by increasing transparency of the particular menu touched by the user, or by lowering transparency of the pop-up menu set in the particular menu.

In step 213, the portable terminal determines whether the user requests to determine the pop-up menu.

When the user requests execution of the menu, rather than determining the pop-up menu, in step 213, the portable terminal in step 219 executes the selected menu determined in step 207.

By contrast, when the user requests a determination of the pop-up menu in step 213, the portable terminal activates the pop-up menu set in the particular menu touched by the user in step 215.

When the pop-up menu determination is not requested before the icon notifying the pop-up menu set disappears, the portable terminal fades in the pop-up menu set in the menu upon the disappearance of the icon. That is, the portable terminal can blurredly activate the pop-up menu set in the menu upon the disappearance of the icon, and then thickly activate the pop-up menu after a certain time.

Next, the portable terminal finishes this process.

While the portable terminal determines whether the touch particular menu includes the pop-up menu when the user performs the short touch input, and the user recognizes the pop-up menu of the particular menu based on the determination result, the portable terminal can inform of the presence or the absence of the pop-up menu using a specific icon when the user attempts the long touch input.

When the portable terminal informs of the presence or the absence of the pop-up menu using a specific icon according to the long touch, it is possible to activate the pop-up menu or to execute the particular menu before the icon disappears. In other words, the user can execute the particular menu by releasing the touch input before the icon disappears, or activate the pop-up menu by maintaining the touch input until the icon disappears.

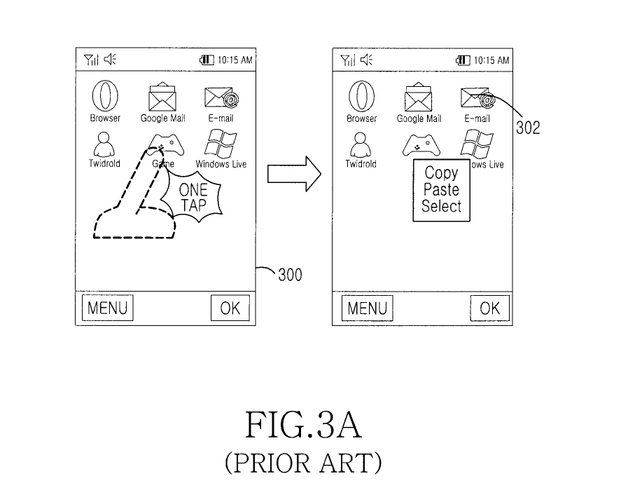

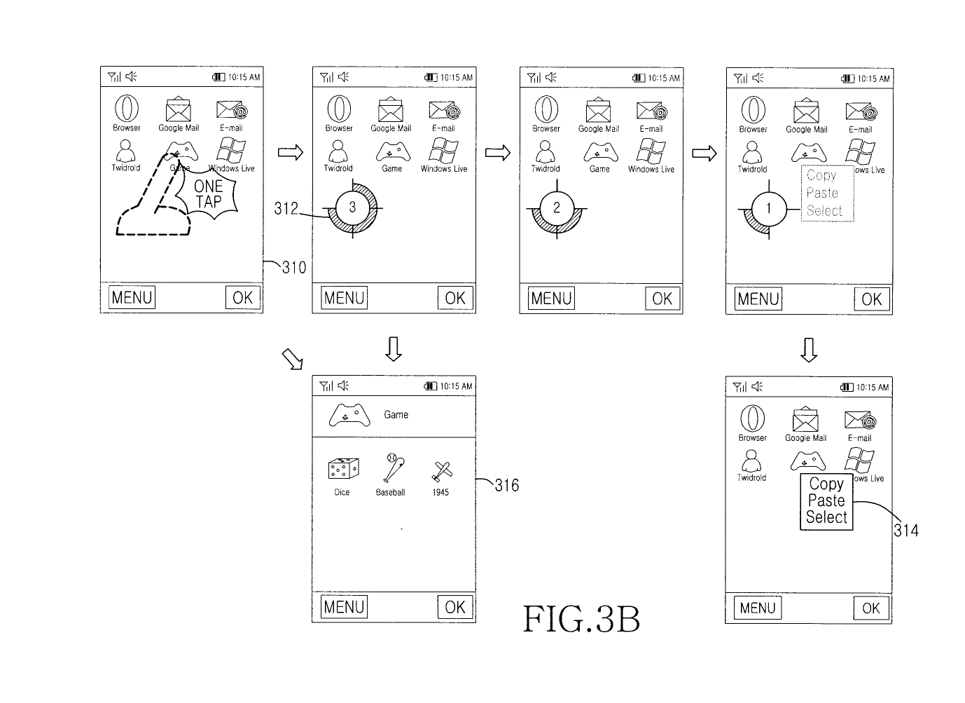

FIG. 3B depicts the pup-up menu determination in the portable terminal according to an exemplary embodiment of the present invention, whereas FIG. 3A is a diagram of the pup-up menu determination in a conventional portable terminal.

To determine the pop-up menu, the portable terminal needs to input the long touch for the particular menu.

As shown in the conventional drawing of FIG. 3A, when the user of the portable terminal intends to determine the pop-up menu for a game menu, the user has to input the long touch in the region corresponding for the game menu in step 300. In response to the long touch input, the portable terminal activates the pop-up menu (Copy, Paste, Select, etc.) corresponding to the menu in step 302.

Still referring to FIG. 3A, the pop-up menu is not set for every menu. Accordingly, when the user cannot recognize the menu including the pop-up menu, it is impossible to activate the pop-up menu.

FIG. 3B is a diagram of the pup-up menu determination in the portable terminal according to an exemplary embodiment of the present invention.

One advantage of the present invention, while the portable terminal can normally receive a long touch input for the particular menu to determine the pop-up menu, the pop-up menu for the particular menu can also be determined with the short touch input in this exemplary embodiment.

As shown in FIG. 3B, when the user of the portable terminal touches the game menu short (the short touch) in step 310, the portable terminal determines whether the pop-up menu is set in the game menu.

When the pop-up menu is not set in the game menu, the portable terminal outputs a list of the games belonging to the game menu by executing the game menu in step 316 as shown in FIG. 3B.

By contrast, as also shown in FIG. 3B, when the pop-up menu is set in the game menu, the portable terminal outputs the icon indicating the set pop-up menu in step 312.

Moreover, as shown in FIG. 3B, the digital timer (in this example the “3” decrements to “2” and then “1”) is provided in an icon 312 informing of the set pop-up menu, and accordingly the user of the portable terminal can request to determine the pop-up menu before the timer expires.

For example, when the user of the portable terminal requests to determine the pop-up menu while the icon 312 is output, the portable terminal activates the pop-up menu (Copy, Paste, Select, etc.) corresponding to the menu in step 314.

At this time, when there is no request from the user for determining the pop-up menu, the timer of the portable terminal expires. As the timer expires, the set pop-up menu is faded in. That is, the portable terminal operates the timer indicating 3 seconds, 2 seconds, and 1 second until the timer expires, outputs the blurred pop-up menu set in the game menu when 1 second is left (when the timer expires), and then fully activates the blurred pop-up menu after a certain time. Alternatively, the portable terminal can fade in the pop-up menu when the timer indicates 2 seconds left and fully activate the pop-up menu when the timer is 0 second. The pop-up menu set in the game menu can be fully activated and output when the timer indicates 0 second, without fading in.

When the user of the portable terminal requests to execute the menu before the output icon 312 disappears, the portable terminal outputs the list of the games belonging to the game menu by executing the game menu in step 316.

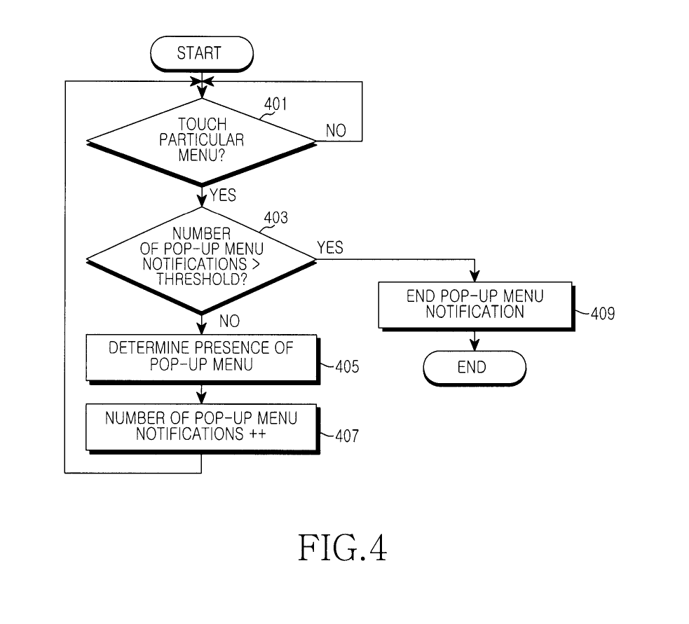

FIG. 4 is a flowchart of a method for informing of the pop-up menu in the portable terminal according to an exemplary embodiment of the present invention.

In step 401, the portable terminal determines whether the user's touch on the particular menu is detected.

When not detecting the particular menu touch in step 401, the portable terminal repeats the step 401.

Upon detecting the particular menu touch in step 401, the portable terminal determines in step 403 whether the number of the pop-up menu notifications for the touched particular menu exceeds a threshold.

When the number of the pop-up menu notifications falls below the threshold in step 403, the portable terminal determines the pop-up menu in step 405 and increases the number of the pop-up menu notifications for the particular menu in step 407.

Next, the portable terminal repeats the pop-up menu notification for the particular menu for less than the threshold back in step 401.

However, when the number of the pop-up menu notifications exceeds the threshold in step 403, the portable terminal processes to end the pop-up menu notification for the particular menu, which is performed over the threshold, in step 409.

Next, the portable terminal finishes this process.

In other words, regarding the process in FIG. 4, with respect to the particular menu, the portable terminal notifies the pop-up menu only for the number of times such that the user can recognize, not every time.

As set forth above, when the particular icon selected with the input for the menu selection includes the pop-up menu, the apparatus and the method for determining the icon of the pop-up menu notifies the pop-up menu set. Therefore, it is possible to determine the pop-up menu for the corresponding icon, without having to remember the icon of the pop-up menu.

The above-described methods according to the present invention can be implemented in hardware or as software or computer code that can be stored in a recording medium such as a CD ROM, an RAM, a floppy disk, a hard disk, or a magneto-optical disk or downloaded over a network and stored on a non-transitory machine readable medium, so that the methods described herein can be rendered in such software using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus for determining a pop-up menu in a portable terminal, comprising:
a display unit;
a controller for detecting whether a menu touch input for executing a menu function is received by a touchscreen of the display unit; and
a pop-up menu guide unit in communication with the controller for determining whether a pop-up menu is set in the menu function detected by the controller and processing the menu function to output information regarding whether or not the pop-up menu is set according to the determination made by the pop-up guide unit.

2. The apparatus of claim 1, wherein, after the information regarding whether or not the pop-up menu is set is output, when a pop-up menu determination request is detected, the pop-up menu guide unit outputs the pop-up menu set in the menu function to the display unit.

3. The apparatus of claim 2, wherein, after the information regarding whether or the pop-up menu is set is output, when the pop-up menu determination request is not detected, the pop-up menu guide unit controls a display of the pop-up menu on the display unit to fade a display of the pop-up menu set in the menu function as the information of whether the pop-up menu is set disappears from display on the display unit.

4. The apparatus of claim 1, wherein, when the pop-up menu is not set in the menu of the touch input, the pop-up menu guide unit executes the menu function corresponding to the touch input, and
when the pop-up menu is set in the menu function of the touch input, the pop-up menu guide unit outputs the information of whether the pop-up menu is set by outputting an icon for display by the display unit notifying of a presence of the pop-up menu.

5. The apparatus of claim 1, wherein the pop-up menu guide unit determines a number of times for determining whether the pop-up menu is set with respect to the menu function corresponding to the detected touch input, determines whether the pop-up menu is set when the number of times for determining whether the pop-up menu is set falls below a threshold, and stops determining whether the pop-up menu is set when the number of times for determining whether the pop-up menu is set exceeds the threshold.

6. The apparatus of claim 1, wherein the icon displayed on the display unit notifying of the presence of the pop-up menu indicates that the pop-up menu set so that a user request to determine whether the pop-up menu is set comprises at least one of a digital timer, a sandglass, and a progress bar, indicating a time for receiving the request from the user.

7. The apparatus of claim 1, wherein the pop-up menu indicates an item for selection of an additional function of a particular menu, and comprises at least one of copy, paste, and select.

8. A method for determining a pop-up menu in a portable terminal, comprising:
detecting by a controller a menu touch input on a touchscreen of a display unit for executing a menu function;
determining by a pop-up guide menu unit whether a pop-up menu is set in the menu function of the touch input; and
outputting information by the pop-up guide menu unit for display on a display unit as to whether the pop-up menu is set according to the determining step by the pop-up guide menu unit.

9. The method of claim 8, further comprising:
after the pop-up guide menu unit outputs the information regarding whether or not the pop-up menu is set, when detecting a pop-up menu determination request, outputting the pop-up menu set in the menu function to a display screen for display.

10. The method of claim 9, further comprising:
after the pop-up guide menu unit outputs the information regarding whether the pop-up menu is set, when not detecting the pop-up menu determination request, fading a display of the pop-up menu set in the menu function as the output information regarding the pop-up menu being set disappears from display by the display unit.

11. The method of claim 8, wherein the outputting of the information of whether the pop-up menu is set comprises:
executing the menu corresponding to the detected touch input by the controller when the pop-up menu is not set in the menu function of the touch input; and
outputting an icon for display on the display unit which notifies of a presence of the pop-up menu when the pop-up menu is set in the menu function of the touch input.

12. The method of claim 8, wherein the determining of whether the pop-up menu is set in the menu of the touch input comprises:
determining by the pop-up menu guide unit the number of times for determining whether the pop-up menu is set with respect to the menu function of the detected touch input;
when the number of times for determining whether the pop-up menu is set falls below a threshold, determining by the pop-up menu guide unit whether the pop-up menu is set; and
when the number of times for determining whether the pop-up menu is set exceeds the threshold, stop determining whether or not the pop-up menu is set.

13. The method of claim 8, wherein the icon displayed by the display unit to notify of the presence of the pop-up menu indicates that the pop-up menu set so that a user requests determination of the pop-up menu, and the icon comprises at least one of a digital timer, a sandglass, and a progress bar, indicating a time for receiving the request from the user.

14. The method of claim 8, wherein the pop-up menu displayed on the display unit indicates an item for an additional function of a particular menu, and comprises at least one of copy, paste, and select.

15. An apparatus for determining a pop-up menu in a portable terminal, comprising:
an input unit for detecting a menu touch input for executing a function;
a controller for determining whether the detected menu touch input comprises a request for a pop-up menu by determining a touch pattern detected by the input unit, and determining whether a pop-up menu is set in the menu function for execution;
a pop-up menu guide unit for, when the controller determines the pop-up menu in the detected menu function, providing information regarding whether or not the pop-up menu is set; and
a display unit for outputting the information provided from the pop-up guide unit.

16. The apparatus of claim 15, wherein the pop-up menu guide unit defines a threshold per menu for the menu function execution, and then provides the information regarding whether or not the pop-up menu is set for the number of times corresponding to the defined threshold.

17. The apparatus of claim 15, wherein, after providing the information regarding whether or not the pop-up menu is set, the pop-up menu guide unit executes a corresponding menu when a menu function execution request is detected, and activates the pop-up menu after a certain time when there is no detection of a menu function execution request.
